(19) United States
(12) Patent Application Publication
(10) Pub. No.: US 2007/0044275 A1
(43) Pub. Date: Mar. 1, 2007

(54) Handle assemblies, brackets, and methods for installing the same

(76) Inventor: William Gurzenda, Somerset, PA (US)

Correspondence Address: MEYER UNKOVIC & SCOTT LLP, 1300 OLIVER BUILDING, PITTSBURGH, PA, 15222, US

(21) Appl. No.: 11/211,314

(22) Filed: Aug. 25, 2005

(51) Int. Cl. E05B 1/00

(52) U.S. Cl. 16/412

(57) ABSTRACT

The present invention discloses various embodiments of a bracket, a push bar handle assembly, a pull bar handle assembly and a method for installing the same that provides a smooth transition from the handle or grip portion of the handle and the bracket.

### BACKGROUND OF THE INVENTION

The present state of the art for the construction of door pulls and push bars from rod, bar or tubular shapes is either to form the material by bending the ends to make projection attachment points or by using a separate cast or fabricated brackets as ends to hold the bar, rod or tube and to provide an attachment means to the door. Such prior art is shown in FIGS. 1 through 3. There are numerous disadvantages to these methods. First, the formation of a door pull or push bar from an extruded shape is expensive to bend, machine, and finish (i.e. polish). The disadvantages of the existing bracket mount pulls and push bars include the aesthetic appearance of a non-uniform shape and the ergonomic discomfort of grasping the uneven surface at the joint of the bracket and tube section.

This present invention addresses many of the above-identified problems by, among other things, utilizing a novel bracket. In the past, brackets have been designed without the benefit of a completely smooth transition from the tube, bar or rod section to the bracket, which holds the tube, rod or bar. Historically, brackets have had either a completely different shape from the tube section or a bulge or projection where the brackets met the tube sections. The present invention discloses a bracket design that matches the shape of the tube or rod precisely and displays a smooth consistent surface from the bracket to the tube or rod section. This smooth appearance is desirable because the push bar or door pull is ergonomically more comfortable with this smooth surface. Additionally, the push bar or door pull is more aesthetically desirable. A popular door pull and push bar shape today is a continuous shape that is bent at the ends to form the bracket or projection and attachment points. The new invention mimics the continuous shape with the benefits of cost, economy of manufacturing, and flexibility of cutting the length of the rod, bar or tube section to fit the door size at the time of installation.

### BRIEF SUMMARY OF THE INVENTION

One embodiment of the present invention is a handle bracket for use in holding an end of a door handle. This bracket comprises a bottom end that rests substantially flush against a door surface and has an attachment mechanism for attaching the bracket to the surface of the door. This bracket also has a top end that fits substantially against the door handle end to provide a smooth surface between the exterior surface of the bracket and the door handle end. This top end comprises a recessed edge for receiving the door handle end. The recessed edge has a bottom shelf-like surface against which the external surface of the door handle end rests. Additionally, the recessed edge is formed to match the cross-sectional geometric shape of the external surface of the door handle end. The top end also has an upper surface that matches the geometric cross-sectional shape of the external surface of the door handle end. Finally, the top end has an interlocking piece that connects with the door handle end.

Another embodiment of the present invention is a handle bracket for use in holding a hollow end of a door handle. The bracket according to this embodiment comprises a bottom end that rests substantially flush against a door surface and has an attachment mechanism for attaching the bracket to the surface of the door. The bracket also has a top end that fits substantially against the door handle end to provide a smooth surface between the exterior surface of the bracket and the door handle end. This top end comprises a recessed edge for receiving the door handle end. The recessed edge has a bottom shelf-like surface against which the external surface of the door handle end rests and where the recessed edge is formed to match the cross-sectional geometric shape of the external surface of the door handle end. The top end also has an upper surface that matches the geometric cross-sectional shape of the external surface of the door handle end and a bracket dowel that is attached to and projects outward from the recessed edge and into the door handle hollow end.

Another embodiment of the present invention includes a push bar handle assembly comprising a hollow bar handle and at least one handle bracket for use in holding one hollow end of the handle. The bracket according to this embodiment of the invention comprises a bottom end and a top end. The bottom end rests substantially flush against a door surface and has an attachment mechanism for attaching the bracket to the surface of the door. The top end fits substantially flush against the door handle end to provide a smooth surface between the exterior surface of the bracket and the door handle end. The top end comprises a recessed edge for receiving the door handle end. The recessed edge has a bottom shelf-like surface against which the external surface of the door handle end rests and the recessed edge is formed to match the cross-sectional geometric shape of the external surface of the door handle end. The top end also has an upper surface that matches the geometric cross-sectional shape of the external surface of the door handle end. Additionally, the top end has a bracket dowel that is attached to and projects outward from the recessed edge and into the door handle hollow end.

Another embodiment of the present invention comprises a pull bar handle assembly comprised of a hollow bar handle and at least one handle bracket for use in holding one hollow end of the handle. The bracket according to this embodiment of the present invention comprises a bottom end that rests substantially flush against a door surface and has an attachment mechanism for attaching the bracket to the surface of the door and a top end that fits substantially flush against the door handle end to provide a smooth surface between the exterior surface of the bracket and the door handle end. The top end comprises a recessed edge for receiving the door handle end. The recessed edge has a bottom shelf-like surface against which the external surface of the door handle end rests and where the recessed edge is formed to match the cross-sectional geometric shape of the external surface of the door handle end. The top end also comprises an upper surface that matches the geometric cross-sectional shape of the external surface of said door handle end and a bracket dowel that is attached to and projects outward from the recessed edge and into the door handle hollow end.

Another embodiment of the present invention discloses a method of installing a bar handle assembly, which method comprises the following steps: (i) installing an attachment dowel near the latch side of a door; (ii) attaching a first handle bracket near the hinge side of the door; (iii) securing a handle end to the first handle bracket; (iv) securing a second handle bracket to the unsecured end of the handle; and (v) attaching the bottom end of the second handle bracket to the attachment dowel. This method uses any of the bracket, push-, and pull-bar assemblies disclosed herein.

### BRIEF DESCRIPTION OF THE DRAWINGS

For the present invention to be easily understood and readily practiced, the invention will now be described, for the purposes of illustration and not limitation, in conjunction with the following figures, wherein:

FIG. 1 illustrates a prior art push bar handle;

FIG. 2 and FIG. 3 illustrate prior art push bar handles;

FIGS. 4A through 4D illustrate various views of one embodiment of a bracket according to the present invention;

FIGS. 5A through 5C illustrate various views of another embodiment of a bracket according to the present invention;

FIG. 6 illustrates one embodiment of a bracket according to the present invention, which is attached to a door surface;

FIGS. 7A through 7D illustrate various views of one embodiment of an angled bracket according to the present invention;

FIGS. 8A through 8D illustrate various views of another embodiment of an angled bracket according to the present invention;

FIG. 9 illustrates one embodiment of a push bar handle assembly having equal length brackets according to the present invention;

FIG. 10 illustrates another embodiment of a push bar handle assembly having brackets of different lengths according to the present invention;

FIG. 11 illustrates an expanded view of the assembly of FIG. 10;

FIG. 12 illustrates one embodiment of a pull bar assembly having equal length brackets according to the present invention; and

FIG. 13 illustrates a cross-sectional view of one embodiment of a handle assembly having a locking mechanism.

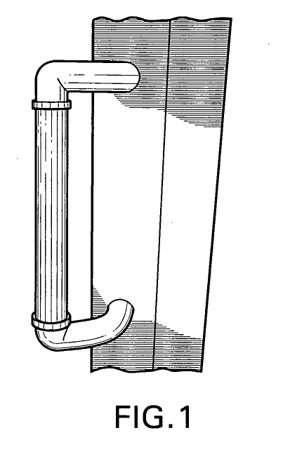

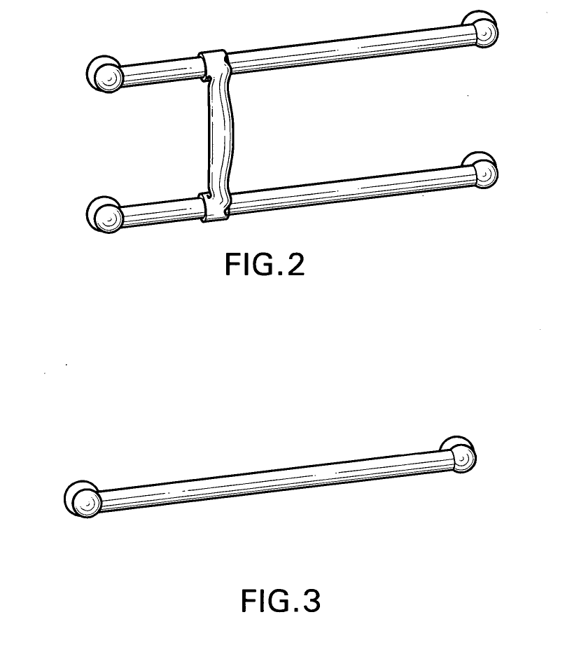

### DESCRIPTION OF THE INVENTION

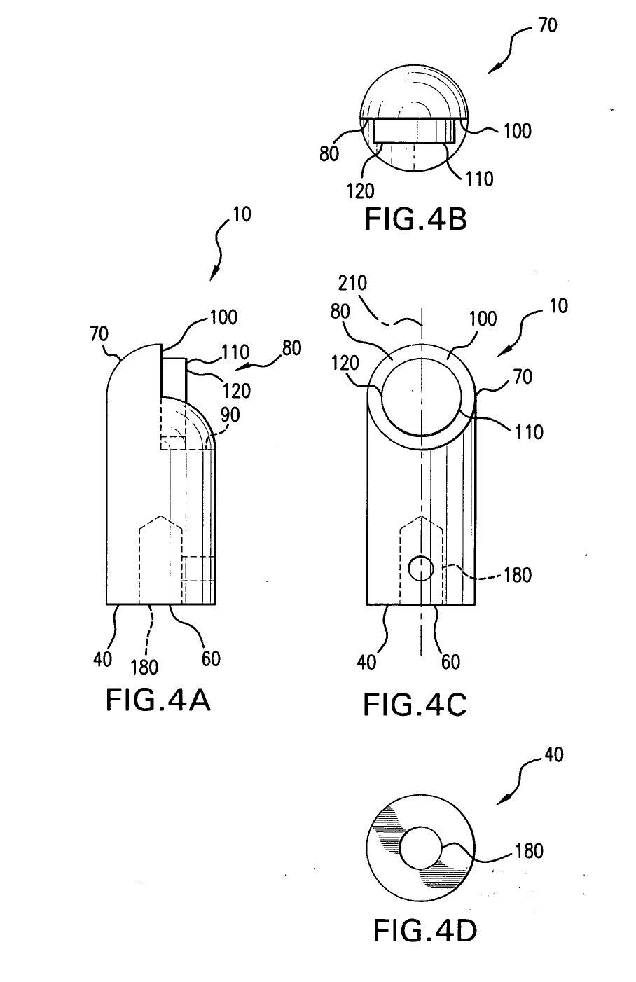

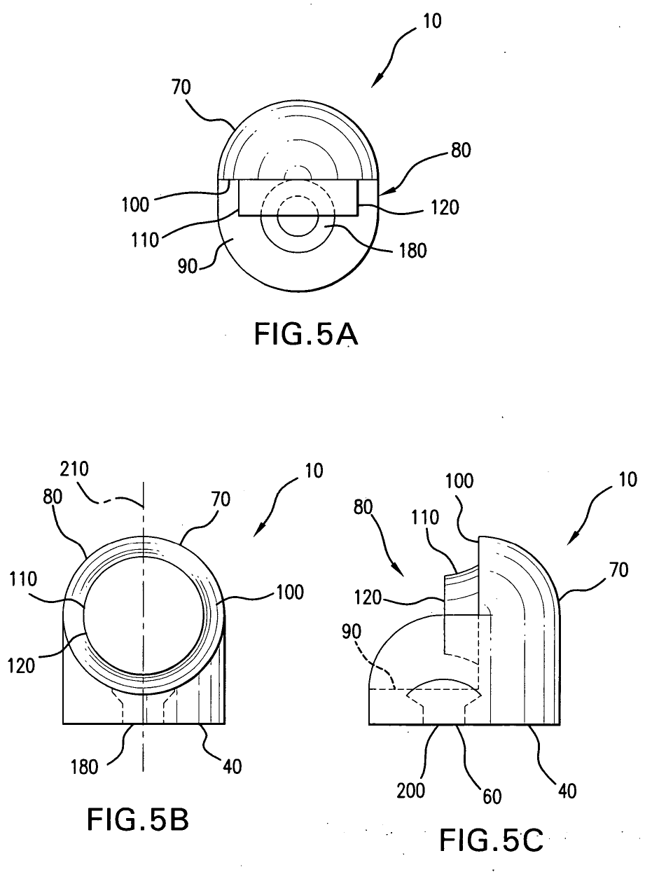

One embodiment of the present invention, shown in FIGS. 4A through 5C, comprises a handle bracket (10) for use in holding an end (30) of a door handle (20). The bracket (10) of this embodiment includes a bottom end (40) that rests substantially flush against a door surface (50) and has an attachment mechanism (60) for attaching the bracket (10) to the surface of the door (50). The bracket (10) according to this embodiment also has a top end (70) that fits substantially flush against the door handle end (30) to provide a smooth surface between the exterior surface of the bracket (10) and the door handle end (30). The top end (70) of this embodiment of the bracket (10) comprises a recessed edge (80) for receiving the door handle end (30). The recessed edge (80) has a bottom shelf-like surface (90) against which the external surface of the door handle end (30) rests and where the recessed edge (80) is formed to match the cross-sectional geometric shape of the external surface of the door handle end (30). The top end (70) also has an upper surface (100) that matches the geometric cross-sectional shape of the external surface of the door handle end (30). Additionally, the top end (70) comprises an interlocking piece (110) that connects with the door handle end (30).

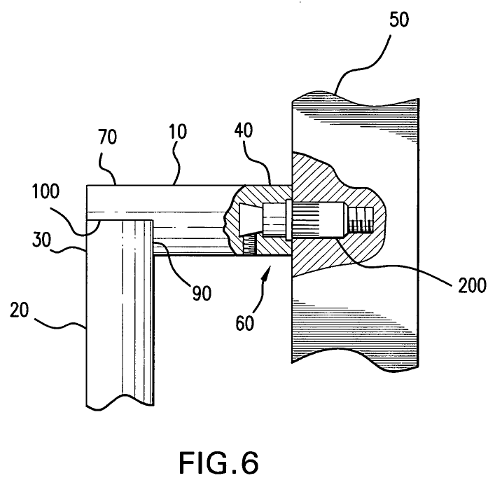

Another embodiment of the present invention, shown in FIGS. 4A through 4D, comprises a handle bracket (10) for use in holding a hollow end of a door handle (20). The bracket (10), according to this embodiment, comprises a bottom end (40) that rests substantially flush against a door surface (50) and has an attachment mechanism (60) for attaching the bracket (10) to the surface of the door (50). One type of attachment mechanism is shown in FIG. 6. The bracket (10), according to this embodiment, also comprises a top end (70) that fits substantially flush against the door handle end (30) to provide a smooth surface between the exterior surface of the bracket (10) and the door handle end (30). This top end (70) comprises a recessed edge (80) for receiving the door handle end (30). The recessed edge (80) has a bottom shelf-like surface (90) against which the external surface of the door handle end (30) rests and where the recessed edge (80) is formed to match the cross-sectional geometric shape of the external surface of the door handle end (30). The top end (70) also has an upper surface (100) that matches the geometric cross-sectional shape of the external surface of the door handle end (30). Additionally, the top end (70) comprises a bracket dowel (120) that attaches to and projects outward from the recessed edge (80) and into the door handle hollow end (30).

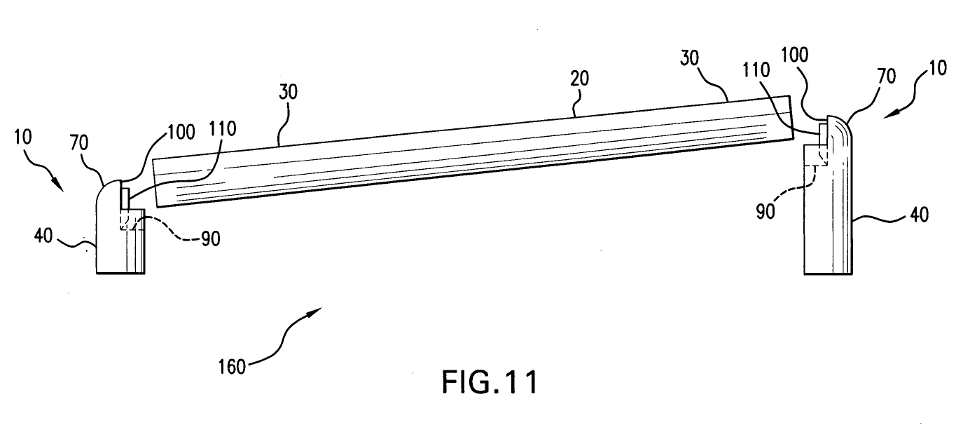

In the preferred embodiment of the present invention, the bracket dowel (120) has a cross-sectional external geometric shape that matches the cross-sectional geometric shape of the interior surface of the door handle hollow end (30), shown in FIG. 11.

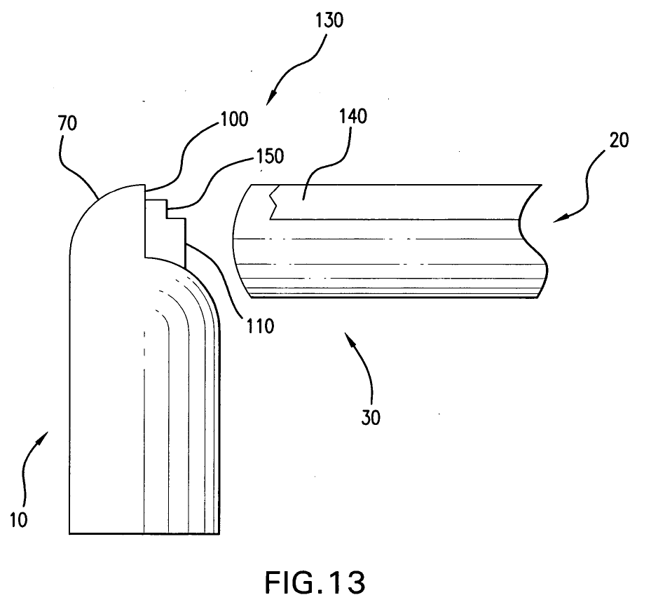

In one embodiment of the present invention, the bracket dowel (120) has a locking mechanism (130) that limits the rotation of the door handle (20) about the bracket dowel (120). This limitation is of particular relevance to door handles (20) and bracket dowels (120) that have a round or circular cross-section. This adds additional comfort to the handle (20) by preventing the rotation of the handle (20) when it is grasped by the user's hand. The locking mechanism (130) may be any of a variety of mechanisms, including but not limited to the following: (i) at least one slot (150) in the external surface of the bracket dowel (120) that receives a projection (140) from the internal surface of the door handle hollow end (30); (ii) at least one projection (140) from the external surface of the dowel (120) that inserts into a slot (150) in the internal surface of the door handle hollow end (30); (iii) at least one slot (150) in the external end of the bracket dowel (120) that receives a projection (140) from the inner end of the door handle (20); or (iv) at least one projection (140) from the end of the bracket dowel (120) that inserts into a slot (150) in the inner end of the door handle (20). One embodiment of the locking mechanism (130) may be a notch (150) in the bracket dowel (120) or interlocking piece (110) and a ridge (140) on the interior surface of the hollow door handle end (30) that fits into the notch (150) and secures the handle (20) against rotation (shown in FIG. 13).

In some embodiments of the present invention, it is desirable to have the handle (20) angled. The handle (20) may be angled in a variety of ways, but many users will prefer that the handle (20) be angled such that the bracket (10) at the latch side of the door (50) is taller than the bracket (10) at the hinge side of the door (50). This results in the handle (20) being angled down from the latch side to the hinge side of the door (50). To accomplish this configuration, the dowel (120) on the taller bracket (10) is angled down toward the surface of the door (50). Such an arrangement is shown in FIG. 10. This embodiment of the present invention also requires that the bracket dowel (120) on the short bracket (10) be angled up away from the surface of the door (50).

Another embodiment of the present invention encompasses a push bar handle assembly (160). One embodiment of a push bar handle assembly (160) according to the present invention comprises a hollow bar handle (20) and at least one handle bracket (10) for use in holding one hollow end (30) of the handle (20). Various embodiments of such push bar handle assemblies (160) may utilize any of the above-described variations of the bracket (10). Additionally, in some embodiments of the present invention assemblies, the entire handle (20) is hollow. In other embodiments, the handle (20) is substantially solid with hollow ends (30). Finally, the handle (20) may have any shape, although the preferred embodiments have a round cross-section or an oval cross-section.

One embodiment of the push bar handle assembly (160) comprises the use of a bracket (10) having a bottom end (40) that rests substantially flush against a door surface (50) and has an attachment mechanism (60) for attaching the bracket (10) to the surface of the door (50). The bracket (10) of this embodiment also has a top end (70) that fits substantially against the door handle end (30) to provide a smooth surface between the exterior surface of the bracket (10) and the door handle end (30). The top end (70) comprises a recessed edge (80) for receiving the door handle end (30). The recessed edge (80) has a bottom shelf-like surface (90) against which the external surface of the door handle end (30) rests and where the recessed edge (80) is formed to match the cross-sectional geometric shape of the external surface of the door handle end (30). The top end (70) also has an upper surface (100) that matches the geometric cross-sectional shape of the external surface of the door handle end (30) and a bracket dowel (120) or interlocking piece (110) that is attached to and projects outward from the recessed edge (80) and into the door handle hollow end (30).

Other embodiments of a push bar handle assembly (160) according to the present invention use the various embodiments of the bracket (10) previously described.

One embodiment of the push bar handle assembly (160) of the present invention comprises a first and a second bracket (10) wherein the first bracket (10) is shorter than the second bracket (10) and wherein the second bracket's (10) bracket dowel (120) is angle down toward the surface of the door (50) and the first bracket's (10) bracket dowel (120) is angled up away from the surface of the door (50). This places the door handle (20) at an angle with respect to the surface of the door (50).

In the preferred embodiment of the present invention push bar handle assembly (160), the second bracket's (10) bracket dowel (120) is angle down 2 to 3 degrees from the horizontal toward the surface of the door (50) and the first bracket's (10) bracket dowel (120) is angled up 2 to 3 degrees from the horizontal away from the surface of the door (50).

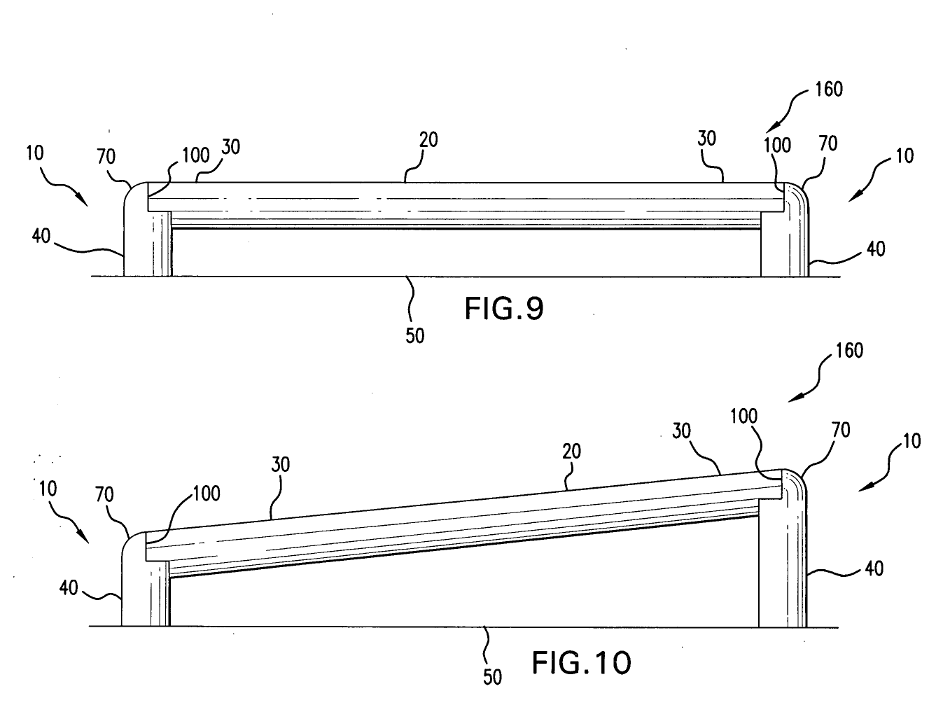

In an alternative embodiment of the present invention push bar handle assembly (160), shown in FIG. 9, a first and a second bracket (10) of equal height are used. The first bracket's (10) bracket dowel (120) and the second bracket's (10) bracket dowel (120) each are at 90 degree angles from the central axis of each bracket (10). This embodiment places the door handle (20) substantially parallel to the surface of the door (50).

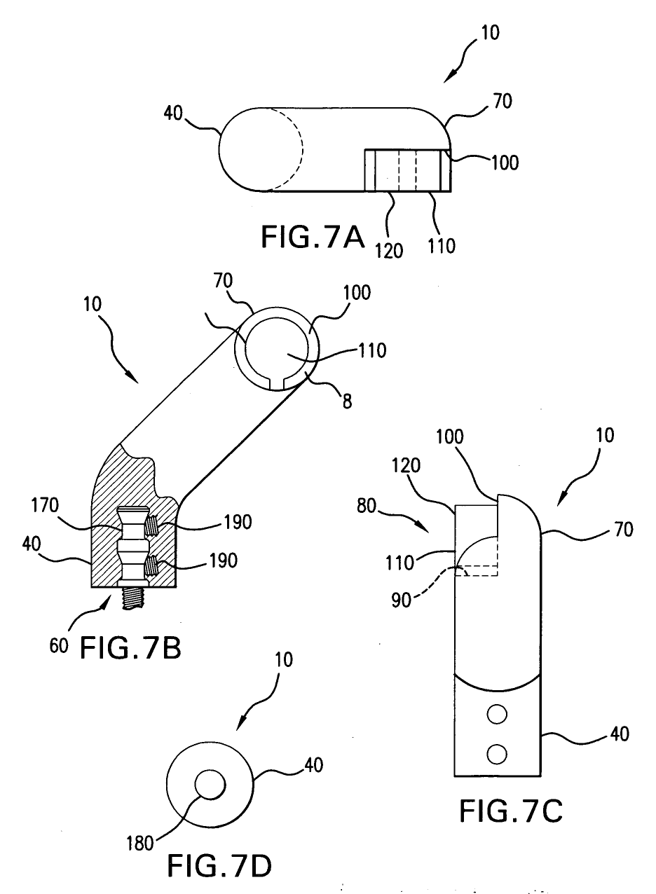

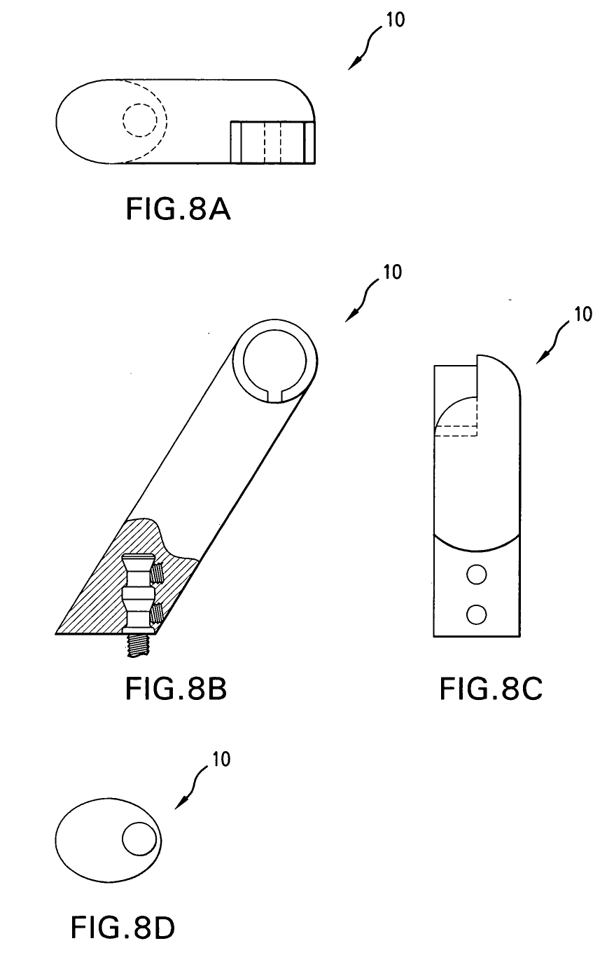

In one embodiment of the present invention push bar handle assembly (160), at least one of the attachment mechanisms (60) comprise an attachment dowel (170) that extends outward from the surface of the door (50) and into a recessed opening (180) in the bottom end (40) of the bracket and at least one adjustable locking mechanism (130). The adjustable locking mechanism (130) may be anything that works, including but not limited to one of the following: a bolt, screw, nail, or pin, which would securely passes through the side of the bracket (10) and into the recessed opening (180) to firmly contact the attachment dowel (170) and prevent the bracket (10) from sliding on the attachment dowel (170). Examples of this recessed opening (180) and attachment dowel (170) attachment mechanism (60) are shown in FIGS. 4A through 4D, 6, 7B through 7D, and 8B through 8D. In one embodiment of this invention, the attachment dowel (170) passes through the door (50) such that one end of the attachment dowel (170) attaches a handle to one side of the door (50) and the other end of the attachment dowel (170) extends into the recessed opening (180) in the bottom end of the bracket (10), which is attached to the opposite side of the door (50). In the preferred embodiment of this push bar handle assembly (160), the attachment dowel (170) is a screw that attaches a handle (20) (pull or push) to the opposite side of the door (50). This screw (170) is sufficiently long to pass through the door (50) and enter the recessed opening (180) on the bracket (10). In the preferred embodiment of this push bar handle assembly (160), this attachment dowel (170) and recessed opening (180) attachment mechanism (60) is used on the longer of the two brackets (10) near the latch side of the door (50).

In another embodiment of the present push bar handle assembly (160), the attachment mechanism (60) comprises at least one fastening device (200), which may be, but is not limited to, a bolt, screw, nail, or pin, that passes through a recessed opening (180) in the bottom end (40) of the bracket (10) and fastens the bracket (10) securely to the door (50). This attachment mechanism (60) is illustrated in FIGS. 5A through 5C.

In some embodiments of the present invention push bar handle assembly (160), the longitudinal central axis (210) of each of the brackets (10) is substantially perpendicular to the plane of the door surface (50). In other embodiments, this angle may be greater or less than 90 degrees to allow for an angling of the door handle (10).

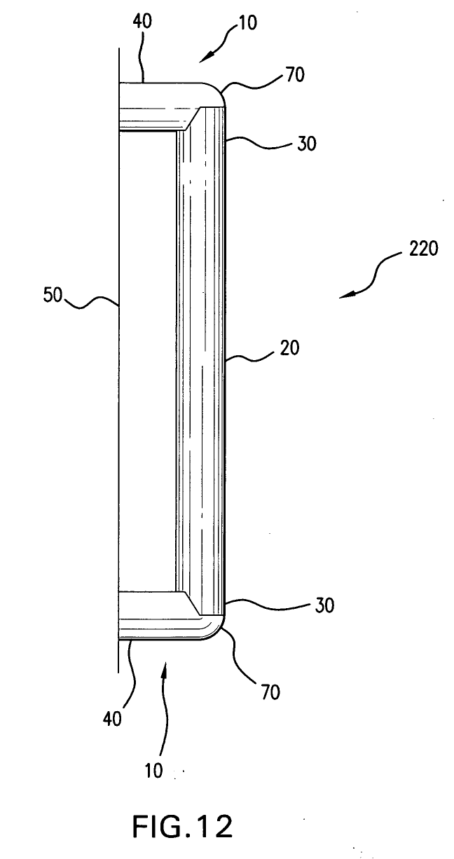

Another embodiment of the present invention discloses a pull bar handle assembly (220). This pull bar handle assembly (220) may be made to incorporate all of the above-detailed variations for the brackets (10) and/or all of the above-detailed variations for the push bar handle assembly (160). The primary differences between the pull bar handle assembly (220) and the push bar handle assembly (160) are that the pull bar handle assembly (220) runs substantially vertical on the door (50) and the push bar handle assembly (160) runs essentially horizontal on the door (50)(some angling and offsetting are anticipated in both designs) and the pull bar handle assembly (220) will often, but not necessarily, be shorter than the push bar handle assembly (160). One example of a pull bar handle assembly (220) according to the present invention is shown in FIG. 12.

Another embodiment of the present invention discloses a method of installing a bar handle assembly (push (160) or pull bar (220)) comprising the following steps: (i) installing an attachment dowel (170) near the latch side of a door (50); (ii) attaching a first handle bracket (10) near the hinge side of the door (50); (iii) securing a handle end (30) to the first handle bracket (10); (iv) securing a second handle bracket (10) to the unsecured end of the handle (30); and (v) attaching the bottom end (40) of the second handle bracket (10) to the attachment dowel (60). This method can be used to install any of the applicable variations of the push bar handle assemblies (160) and pull bar handle assemblies (220) described in the preceding paragraphs.

In the preferred embodiment of this method, the brackets (10) are of different lengths with the first bracket (10) being shorter than the second bracket (10) and with the second bracket's (10) bracket dowel (120) being angle down toward the surface of the door (50) and the first bracket's (10) bracket dowel (120) being angled up away from the surface of the door (50). In this preferred embodiment, the attachment mechanism (60) of the second bracket comprising a recessed opening (180) in the bottom end (40) of the bracket (10) for receiving the attachment dowel (170) and at least one adjustable locking mechanism (190), selected from the group consisting of a bolt, screw, nail, or pin, that securely passes through the side of the bracket (10) and into the recessed opening (180) to firmly contact the attachment dowel (170) and to prevent the bracket (10) from sliding on the attachment dowel (170).

Additionally in the preferred embodiment of the method according to the present invention, the first bracket (10) attaches to the door by using an attachment mechanism (60) that comprises at least one fastening device (200), which fastening device is selected from the group consisting of a bolt, screw, nail, or pin, that passes through a recessed opening (180) in the bottom end (40) of the bracket (10) and fastens the bracket (10) securely to the door (50).

A bracket (10) according to the present invention may be made to any height to conform to the projection of the handle (20) from the door (50) that the user desires. In some cases, a shorter bracket (10) may be used at the hinge side of a door (50) and a longer bracket (10) may be used at the latch side of the door (50). Such an arrangement provides a “single projection” style push bar handle assembly (160). In the case of a door pull handle assembly (220), the brackets (10) can be made with an angled bottom end (40) to provide an offset to the grip section of the door pull handle (20). Such a pull bar handle assembly (220) is useful in the case of narrow style doors (50).

In the preferred embodiments of the present invention assemblies, at least one of the brackets (10) is attached to the door (50) at the bottom end (40) of the bracket (10) with a thru bolt or concealed style mounting that engages a recessed opening (180) in the bottom end (40) of the bracket (10) (FIGS. 4A, 4C, 4D, 6, 7B through 7D, and 8B through 8D). Alternately, the bracket (10) may attach from the front surface with a flat head screw (FIG. 5C). In such a case, the bracket (10) may be somewhat elongated to allow room for a countersunk hole for mounting and the fastening device (200) to engage the bracket (10).

The above-provided discussion of various embodiments of the present invention is intended to be an illustrative, but not exhaustive, list of possible embodiments. It will be obvious to one skilled in the art that other embodiments are possible and are included within the scope of this invention.

1. A handle bracket for use in holding an end of a door handle, said bracket comprising:
a bottom end that rests substantially flush against a door surface and has an attachment mechanism for attaching said bracket to the surface of said door; and
a top end that fits substantially flush against said door handle end to provide a smooth surface between the exterior surface of said bracket and said door handle end, said top end comprising:
a recessed edge for receiving said door handle end, said recessed edge having a bottom shelf-like surface against which the external surface of said door handle end rests and where said recessed edge is formed to match the cross-sectional geometric shape of the external surface of said door handle end;
an upper surface that matches the geometric cross-sectional shape of the external surface of said door handle end; and
an interlocking piece that connects with said door handle end.

2. A handle bracket for use in holding a hollow end of a door handle, said bracket comprising:
a bottom end that rests substantially flush against a door surface and has an attachment mechanism for attaching said bracket to the surface of said door; and
a top end that fits substantially flush against said door handle end to provide a smooth surface between the exterior surface of said bracket and said door handle end, said top end comprising:
a recessed edge for receiving said door handle end, said recessed edge having a bottom shelf-like surface against which the external surface of said door handle end rests and where said recessed edge is formed to match the cross-sectional geometric shape of the external surface of said door handle end;
an upper surface that matches the geometric cross-sectional shape of the external surface of said door handle end; and
a bracket dowel that is attached to and projects outward from said recessed edge and into said door handle hollow end.

3. The bracket of claim 2, wherein said bracket dowel has a cross-sectional external geometric shape that matches the cross-sectional geometric shape of the interior surface of said door handle hollow end.

4. The bracket of claim 2, wherein said bracket dowel has a locking mechanism that limits the rotation of said door handle about said bracket dowel.

5. The bracket of claim 4, wherein said locking mechanism is selected from the group consisting of (i) at least one slot in the external surface of said bracket dowel that receives a projection from the internal surface of said door handle hollow end, (ii) at least one projection from the external surface of said dowel that inserts into a slot in the internal surface of said door handle hollow end, (iii) at least one slot in the external end of said bracket dowel that receives a projection from the inner end of said door handle, and (iv) at least one projection from the end of said bracket dowel that inserts into a slot in the inner end of said door handle.

6. The bracket of claim 2, wherein said bracket dowel is angled down toward the surface of said door.

7. The bracket of claim 2, wherein said bracket dowel is angled up from the surface of said door.

8. A push bar handle assembly comprising:
a hollow bar handle; and
at least one handle bracket for use in holding one hollow end of said handle, said bracket comprising:
a bottom end that rests substantially flush against a door surface and has an attachment mechanism for attaching said bracket to the surface of said door; and
a top end that fits substantially flush against said door handle end to provide a smooth surface between the exterior surface of said bracket and said door handle end, said top end comprising:
a recessed edge for receiving said door handle end, said recessed edge having a bottom shelf-like surface against which the external surface of said door handle end rests and where said recessed edge is formed to match the cross-sectional geometric shape of the external surface of said door handle end;
an upper surface that matches the geometric cross-sectional shape of the external surface of said door handle end; and
a bracket dowel that is attached to and projects outward from said recessed edge and into said door handle hollow end.

9. The assembly of claim 8, wherein each of said bracket dowels has a cross-sectional external geometric shape that matches the cross-sectional geometric shape of the interior surface of said door handle hollow end.

10. The assembly of claim 8, wherein at least one of said bracket dowels has a locking mechanism that limits the rotation of said door handle about said bracket dowel.

11. The assembly of claim 10, wherein said locking mechanism is selected from the group consisting of (i) at least one slot in the external surface of said bracket dowel that receives a projection from the internal surface of said door handle hollow end, (ii) at least one projection from the external surface of said bracket dowel that inserts into a slot in the internal surface of said door handle hollow end, (iii) at least one slot in the external end of said bracket dowel that receives a projection from the inner end of said door handle, and (iv) at least one projection from the end of said bracket dowel that inserts into a slot in the inner end of said door handle.

12. The assembly of claim 8, comprising a first and a second bracket wherein said first bracket is shorter than said second bracket and wherein said second bracket's bracket dowel is angle down toward the surface of the door and said first bracket's bracket dowel is angled up away from the surface of the door.

13. The assembly of claim 12, wherein said second bracket's bracket dowel is angle down 2 to 3 degrees from the horizontal toward the surface of the door and said first bracket's bracket dowel is angled up 2 to 3 degrees from the horizontal away from the surface of the door.

14. The assembly of claim 8, comprising a first and a second bracket of equal height and wherein said first bracket's bracket dowel and said second bracket's bracket dowel each are at 90 degree angles from the central axis of each bracket.

15. The assembly of claim 8, wherein said at least one attachment mechanism comprises:
an attachment dowel that extends outward from the surface of said door and into a recessed opening in said bottom end of said bracket; and
at least one adjustable locking mechanism, selected from the group consisting of a bolt, screw, nail, and pin, that securely passes through the side of said bracket and into said recessed opening to firmly contact said attachment dowel and prevents said bracket from sliding on said attachment dowel.

16. The assembly of claim 15, wherein said attachment dowel passes through the door such that one end of said attachment dowel attaches a handle to the opposite side of said door and the other end of said attachment dowel extends into said recessed opening in said bottom end of said bracket.

17. The assembly of claim 8, wherein said attachment mechanism comprises at least one fastening device, selected from the group consisting of a bolt, screw, nail, and pin, that passes through a recessed opening in said bottom end of said bracket and fastens said bracket securely to said door.

18. The assembly of claim 8, wherein the longitudinal central axis of each of said brackets is substantially perpendicular to the plane of the door surface.

19. The assembly of claim 8, wherein the longitudinal central axis of each of said brackets is angled so that the angle formed by the central axis and the plan of the door surface is less than 90 degrees.

20. A pull bar handle assembly comprising:
a hollow bar handle; and
at least one handle bracket for use in holding one hollow end of said handle, said bracket comprising:
a bottom end that rests substantially flush against a door surface and has an attachment mechanism for attaching said bracket to the surface of said door; and
a top end that fits substantially flush against said door handle end to provide a smooth surface between the exterior surface of said bracket and said door handle end, said top end comprising:
a recessed edge for receiving said door handle end, said recessed edge having a bottom shelf-like surface against which the external surface of said door handle end rests and where said recessed edge is formed to match the cross-sectional geometric shape of the external surface of said door handle end;
an upper surface that matches the geometric cross-sectional shape of the external surface of said door handle end; and
a bracket dowel that is attached to and projects outward from said recessed edge and into said door handle hollow end.

21. The assembly of claim 20, wherein each of said bracket dowels has a cross-sectional external geometric shape that matches the cross-sectional geometric shape of the interior surface of said door handle hollow end.

22. The assembly of claim 20, wherein at least one of said bracket dowels has a locking mechanism that limits the rotation of said door handle about said bracket dowel.

23. The assembly of claim 22, wherein said locking mechanism is selected from the group consisting of (i) at least one slot in the external surface of said bracket dowel that receives a projection from the internal surface of said door handle hollow end, (ii) at least one projection from the external surface of said bracket dowel that inserts into a slot in the internal surface of said door handle hollow end, (iii) at least one slot in the external end of said bracket dowel that receives a projection from the inner end of said door handle, and (iv) at least one projection from the end of said bracket dowel that inserts into a slot in the inner end of said door handle.

24. The assembly of claim 20, comprising a first and a second bracket wherein said first bracket is shorter than said second bracket and wherein said second bracket's bracket dowel is angle down toward the surface of the door and said first bracket's bracket dowel is angled up away from the surface of the door.

25. The assembly of claim 24, wherein said second bracket's bracket dowel is angle down 2 to 3 degrees from the horizontal toward the surface of the door and said first bracket's bracket dowel is angled up 2 to 3 degrees from the horizontal away from the surface of the door.

26. The assembly of claim 20, comprising a first and a second bracket of equal height and wherein said first bracket's bracket dowel and said second bracket's bracket dowel each are at 90 degree angles from the central axis of each bracket.

27. The assembly of claim 20, wherein said at least one attachment mechanism comprises:
an attachment dowel that extends outward from the surface of said door and into a recessed opening in said bottom end of said bracket; and
at least one adjustable locking mechanism, selected from the group consisting of a bolt, screw, nail, and pin, that securely passes through the side of said bracket and into said recessed opening to firmly contact said attachment dowel and prevents said bracket from sliding on said attachment dowel.

28. The assembly of claim 27, wherein said attachment dowel passes through the door such that one end of said attachment dowel attaches a handle to the opposite side of said door and the other end of said attachment dowel extends into said recessed opening in said bottom end of said bracket.

29. The assembly of claim 20, wherein said attachment mechanism comprises at least one fastening device, selected from the group consisting of a bolt, screw, nail, and pin, that passes through a recessed opening in said bottom end of said bracket and fastens said bracket securely to said door.

30. The assembly of claim 20, wherein the longitudinal central axis of each of said brackets is substantially perpendicular to the plane of the door surface.

31. The assembly of claim 20, wherein the longitudinal central axis of each of said brackets is angled so that the angle formed by the central axis and the plan of the door surface is less than 90 degrees.

32. A method of installing a bar handle assembly comprising:
installing an attachment dowel near the latch side of a door;
attaching a first handle bracket near the hinge side of said door;
securing a handle end to said first handle bracket;
securing a second handle bracket to the unsecured end of said handle; and
attaching the bottom end of said second handle bracket to said attachment dowel, wherein each of said brackets comprise:
a bottom end that rests substantially flush against a door surface and has an attachment mechanism for attaching said bracket to the surface of said door; and
a top end that fits substantially flush against said door handle end to provide a smooth surface between the exterior surface of said bracket and said door handle end, said top end comprising:
a recessed edge for receiving said door handle end, said recessed edge having a bottom shelf-like surface against which the external surface of said door handle end rests and where said recessed edge is formed to match the cross-sectional geometric shape of the external surface of said door handle end;
an upper surface that matches the geometric cross-sectional shape of the external surface of said door handle end; and
a bracket dowel that is attached to and projects outward from said recessed edge and into said door handle hollow end and has a cross-sectional external geometric shape that matches the cross-sectional geometric shape of the interior surface of said door handle hollow end.

33. The method of claim 32, wherein at least one of said bracket dowels has a locking mechanism that limits the rotation of said door handle about said bracket dowel.

34. The method of claim 32, wherein said first bracket is shorter than said second bracket and wherein said second bracket's bracket dowel is angle down toward the surface of the door and said first bracket's bracket dowel is angled up away from the surface of the door.

35. The method of claim 32, wherein said at least one attachment mechanism comprises:
a recessed opening in said bottom end of said bracket for receiving said attachment dowel; and
at least one adjustable locking mechanism, selected from the group consisting of a bolt, screw, nail, and pin, that securely passes through the side of said bracket and into said recessed opening to firmly contact said attachment dowel and prevents said bracket from sliding on said attachment dowel.

36. The assembly of claim 35, wherein said first bracket is attached to said door by using said attachment mechanism, wherein said attachment mechanism comprises at least one fastening device, selected from the group consisting of a bolt, screw, nail, and pin, that passes through a recessed opening in said bottom end of said bracket and fastens said bracket securely to said door.
